(19) United States
(12) Patent Application Publication
(10) Pub. No.: US 2024/0282089 A1
(43) Pub. Date: Aug. 22, 2024

(54) LEARNING APPARATUS, INFERENCE APPARATUS, LEARNING METHOD, INFERENCE METHOD, NON-TRANSITORY COMPUTER-READABLE STORAGE MEDIUM

(71) Applicant: CANON KABUSHIKI KAISHA, Tokyo (JP)

(72) Inventor: Motoki KITAZAWA, Tokyo (JP)

(21) Appl. No.: 18/438,670

(22) Filed: Feb. 12, 2024

(30) Foreign Application Priority Data
Feb. 20, 2023 (JP) 2023-024622

(51) Int. Cl. G06V 10/778; G06V 10/22

(52) U.S. Cl. CPC G06V 10/778; G06V 10/22

(57) ABSTRACT

A learning apparatus comprises one or more memories storing instructions and one or more processors that execute the instructions to acquire a likelihood map of a specific part in an input image by using a first model for detecting the specific part, acquire a region map representing a region of a specific part of a tracking target in the input image by using a second model for detecting the tracking target, and perform learning of the second model based on a loss obtained based on an element product map obtained by an element product of the likelihood map and the region map and correct answer data indicating a region of a specific part of a tracking target in the input image.

### BACKGROUND

### Field

The present disclosure relates to a tracking technique.

### Description of the Related Art

As a technique for continuously detecting a specific subject from each frame in a moving image and performing tracking, there is a technique using luminance and color information, a technique using template matching, a technique using a convolutional neural network (CNN), and the like. These techniques are used for a surveillance camera equipped with a function of tracking a subject, a camera equipped with an autofocus function of automatically focusing on a subject, and the like.

In addition, a technique for detecting a specific part of a subject is also known. It is conceivable that such a technology is used for, for example, focusing on the eyes of a person or an animal of a subject at a pinpoint.

Such a technique includes a top-down approach of detecting an entire region of a subject and detecting a specific part in the region, and a bottom-up approach of detecting a plurality of specific parts and determining the specific part of the subject by associating them. In the bottom-up approach, when the specific parts are associated with each other, the specific parts may be erroneously associated with a specific part of an object different from the subject. In Japanese Patent Laid-Open No. 2022-510417, the correspondence of each specific part is output by estimating an affinity map representing the correspondence between the specific parts.

When specific parts of the same object are corresponded with each other from among the separately detected specific parts, the specific parts may be erroneously corresponded with a part of another object present nearby. For example, when the person on the near side and the person on the far side are close to each other on the image, the eyes of the person on the near side may be erroneously corresponded with the eyes of the person on the far side.

### SUMMARY

According to the first aspect of the present invention, there is provided a learning apparatus comprising one or more memories storing instructions and one or more processors that execute the instructions to: acquire a likelihood map of a specific part in an input image by using a first model for detecting the specific part; acquire a region map representing a region of a specific part of a tracking target in the input image by using a second model for detecting the tracking target; and perform learning of the second model based on a loss obtained based on an element product map obtained by an element product of the likelihood map and the region map and correct answer data indicating a region of a specific part of a tracking target in the input image.

According to the second aspect of the present invention, there is provided an inference apparatus comprising one or more memories storing instructions and one or more processors that execute the instructions to: acquire a likelihood map of a specific part in an input image by using a first model for detecting the specific part; acquire a region map representing a region of a specific part of a tracking target in the input image by using a second model for detecting the tracking target; and detect a position of the specific part in the input image based on an element product map obtained by an element product of the likelihood map and the region map.

According to the third aspect of the present invention, there is provided a learning method comprising: acquiring a likelihood map of a specific part in an input image by using a first model for detecting the specific part; acquiring a region map representing a region of a specific part of a tracking target in the input image by using a second model for detecting the tracking target; and performing learning of the second model based on a loss obtained based on an element product map obtained by an element product of the likelihood map and the region map and correct answer data indicating a region of a specific part of a tracking target in the input image.

According to the fourth aspect of the present invention, there is provided an inference method comprising: acquiring a likelihood map of a specific part in an input image by using a first model for detecting the specific part; acquiring a region map representing a region of a specific part of a tracking target in the input image by using a second model for detecting the tracking target; and detecting a position of the specific part in the input image based on an element product map obtained by an element product of the likelihood map and the region map.

According to the fifth aspect of the present invention, there is provided a non-transitory computer-readable storage medium storing a computer program for causing a computer to function as: a first acquisition unit configured to acquire a likelihood map of a specific part in an input image by using a first model for detecting the specific part; a second acquisition unit configured to acquire a region map representing a region of a specific part of a tracking target in the input image by using a second model for detecting the tracking target; and a learning unit configured to perform learning of the second model based on a loss obtained based on an element product map obtained by an element product of the likelihood map and the region map and correct answer data indicating a region of a specific part of a tracking target in the input image.

According to the sixth aspect of the present invention, there is provided a non-transitory computer-readable storage medium storing a computer program for causing a computer to function as: a first acquisition unit configured to acquire a likelihood map of a specific part in an input image by using a first model for detecting the specific part; a second acquisition unit configured to acquire a region map representing a region of a specific part of a tracking target in the input image by using a second model for detecting the tracking target; and a detection unit configured to detect a position of the specific part in the input image based on an element product map obtained by an element product of the likelihood map and the region map.

To provide a technique for correctly associating specific parts of the same object with each other even when another object exists nearby.

Further features of the present disclosure will become apparent from the following description of exemplary embodiments with reference to the attached drawings.

### BRIEF DESCRIPTION OF THE DRAWINGS

FIG. 1 is a block diagram illustrating an exemplary functional configuration of a learning apparatus 100;

FIG. 2 is a flowchart of a learning process of a model by the learning apparatus 100;

FIG. 3 is a schematic diagram of processes in steps S101 to S103;

FIG. 4 is a diagram illustrating an example of a process for obtaining an average vector;

FIG. 5 is a block diagram illustrating a functional configuration example of an inference apparatus 200;

FIG. 6 is a flowchart of a process performed by the inference apparatus 200;

FIG. 7 is a block diagram illustrating an exemplary functional configuration of a learning apparatus 700;

FIG. 8 is a flowchart of a learning process of the learning apparatus 700; and

FIG. 9 is a block diagram illustrating a hardware configuration example of a computer apparatus.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but limitation is not made to an embodiment that requires all such features, and multiple such features may be combined as appropriate. Furthermore, in the attached drawings, the same reference numerals are given to the same or similar configurations, and redundant description thereof is omitted.

### First Embodiment

In the present embodiment, a learning apparatus that learns a model for detecting a specific part of a tracking target in an input image will be described. More specifically, in the present embodiment, an example of a learning apparatus that acquires a likelihood map of a specific part in an input image using a first model for detecting the specific part, acquires a region map representing a region of the specific part of the tracking target in the input image using a second model for detecting the tracking target, and performs learning of the second model based on a loss obtained on the basis of an element product map obtained by an element product of the likelihood map and the region map and correct answer data indicating a region of the specific part of the tracking target in the input image will be described.

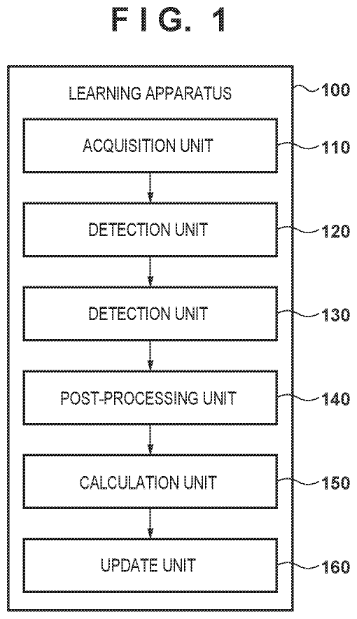

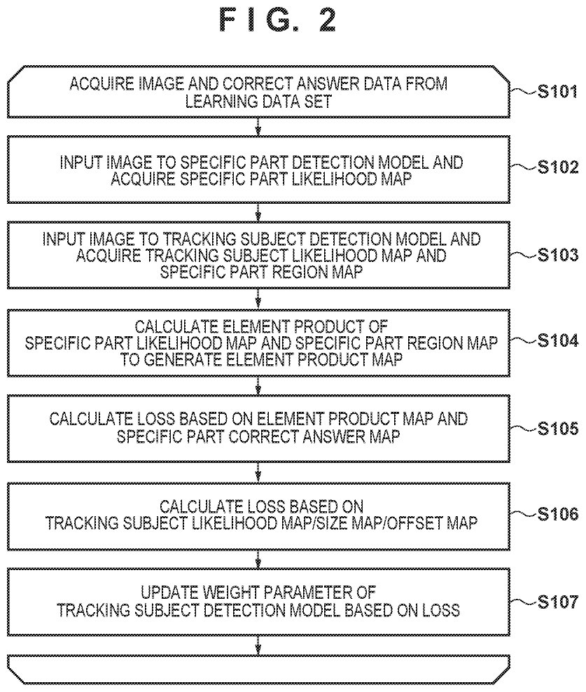

FIG. 1 is a block diagram illustrating an exemplary functional configuration of a learning apparatus 100, according to the present embodiment. A learning process of a model by the learning apparatus 100 according to the present embodiment will be described with reference to the flowchart of FIG. 2.

The learning apparatus 100 according to the present embodiment holds a learning data set used in the learning process. The learning data set includes a set of continuous images (continuous image set) and correct answer data corresponding to the images.

It is assumed that one or more objects including a tracking subject that is a subject serving as a tracking target are captured in each image included in the continuous image set. The continuous image set is, for example, a moving image, and in this case, each frame in the moving image corresponds to the above image.

The correct answer data includes first region information defining an image region of the tracking subject included in the image corresponding to the correct answer data, and second region information defining an image region of a specific part of the object included in the image.

In the present embodiment, a case will be described in which the first region information is information indicating the center coordinate of a rectangular region surrounding the image region of the tracking subject and the width and height of the rectangular region. Furthermore, in the present embodiment, a case will be described in which the second region information is information indicating the center coordinate of a rectangular region surrounding the image region of the specific part and the width and height of the rectangular region. In addition, in the present embodiment, a case where the tracking subject is a person and the specific part is a head will be described. Note that the specific parts may be any parts of the object, and the number thereof is not limited to a specific number.

In step S101, an acquisition unit 110 acquires an unselected image and correct answer data corresponding to the image from a learning data set. For example, when the continuous image set is a moving image, the acquisition unit 110 acquires images in order from the head frame, and acquires correct answer data corresponding to the images.

In step S102, a detection unit 120 inputs the image acquired in step S101 to a specific part detection model and performs a calculation process of the specific part detection model. Here, the specific part detection model is “a learned model configured to output a map (specific part likelihood map) indicating likelihood (likelihood that the pixel position is included in the specific part) corresponding to the pixel position of the input image”. As the specific part detection model, a learning model such as CNN or Transformer can be applied, and for example, a learning model disclosed in Single Shot Multibox Detector (ECCV 2016) can be applied. The detection unit 120 acquires “the specific part likelihood map corresponding to the image acquired in step S101” that is the output of the specific part detection model by such a calculation process.

Note that the detection unit 120 may acquire a “size map indicating the size of the specific part included in the image acquired in step S101”, “offset map representing correction information for correcting the position of a specific part included in the images acquired in step S101”, or the like using the specific part detection model or other learned models.

In step S103, the detection unit 130 inputs the image acquired in step S101 to the tracking subject detection model and performs a calculation process of the tracking subject detection model. Here, the tracking subject detection model is a “model learned to output the tracking subject likelihood map and the specific part region map”. As the tracking subject detection model, a learning model such as CNN or Transformer can be applied, and for example, the learning model disclosed in Real-Time MDNet (ECCV 2018) can be applied. Here, the tracking subject likelihood map is “a map indicating likelihood corresponding to pixel position of input image (likelihood that pixel position is included in tracking subject)”, and the specific part region map is a map indicating a region where the specific part of the tracking subject can exist in the image. The detection unit 130 acquires “a tracking subject likelihood map and a specific part region map corresponding to the images acquired in step S101” which is an output of the tracking subject detection model by such a calculation process.

Note that the detection unit 130 may acquire a “size map indicating the size of the tracking subject included in the image acquired in step S101”, “offset map representing correction information for correcting the position of the tracking subject included in the images acquired in step S101”, or the like using the tracking subject detection model or other learned models. The vertical and horizontal sizes of these maps are the same as the vertical and horizontal sizes of the specific part likelihood map.

In step S104, a post-processing unit 140 generates a map obtained by calculating an element product of the specific part likelihood map acquired in step S102 and the specific part region map acquired in step S103 as an element product map.

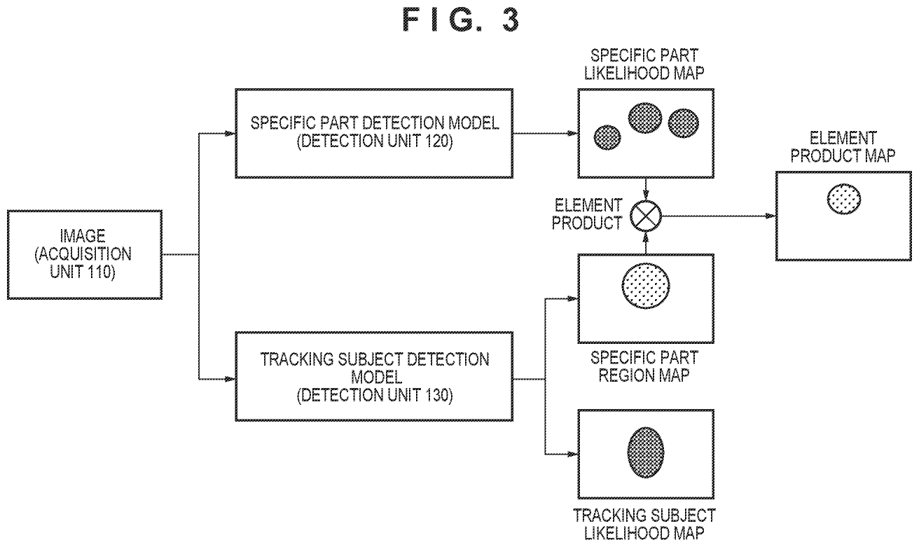

FIG. 3 shows a schematic diagram of the processes of steps S101 to S103. The image acquired by the acquisition unit 110 is input to the specific part detection model and the tracking subject detection model. A specific part likelihood map is output by a calculation process of the specific part detection model by the detection unit 120 from the specific part detection model. On the other hand, the tracking subject likelihood map and the specific part region map are output by a calculation process of the tracking subject detection model by the detection unit 130 from the tracking subject detection model. Then, the post-processing unit 140 generates a map obtained by calculating the element product of the specific part likelihood map and the specific part region map as the element product map.

In step S105, the calculation unit 150 generates the specific part correct answer map based on the correct answer data acquired in step S101, and obtains a loss for the specific part likelihood by using the specific part correct answer map and the element product map generated in step S104. Here, the process performed by the calculation unit 150 to generate the specific part correct answer map based on the correct answer data will be described.

The specific part correct answer map is a map obtained by replacing the second region information included in the correct answer data with a two-dimensional likelihood distribution, and is a map of a correct answer with respect to the specific part likelihood map. Here, it is assumed that a two-dimensional standard normal distribution represented by the following formula (1) is used as the two-dimensional likelihood distribution.

$$\begin{matrix}[ Equation 1 ] & \\ p ( \vec{x} ) = \frac{1}{2 π} exp [ - \frac{{( \vec{x} - \vec{μ} )}^{2}}{2} ] ( \vec{x} = ( x , y ) , \vec{μ} = ( {μ}_{x} , {μ}_{y} ) ) & ( 1 )\end{matrix}$$

$$\vec{x} \qquad [ Equation 2 ]$$

is a vector representing two dimensional coordinates (x, y) in the specific part correct answer map, and

$$p ( \vec{x} ) \qquad [ Equation 3 ]$$

represents the likelihood at two dimensional coordinates (x, y).

$$\vec{μ} \qquad [ Equation 4 ]$$

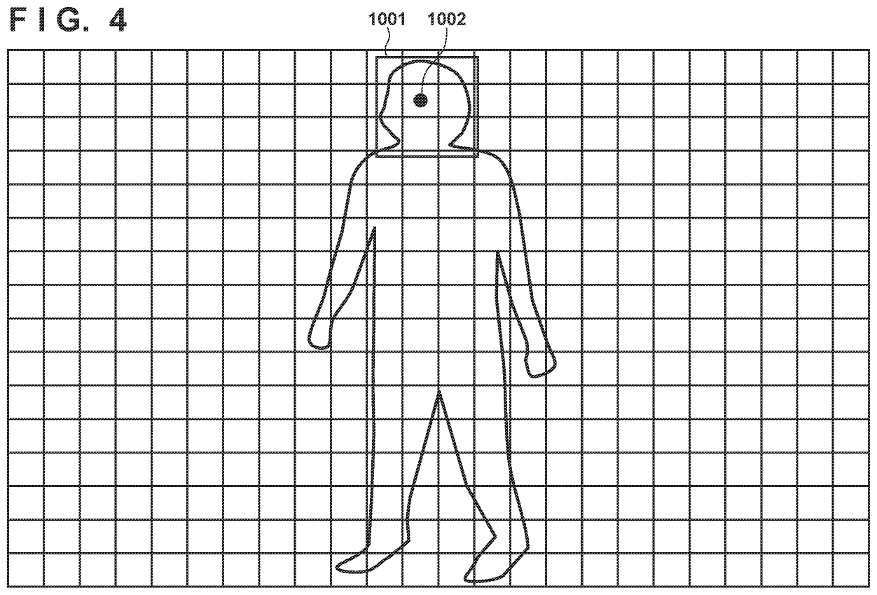

is an average vector in the specific part correct answer map, and is a vector having μx which is an average value in the x axis direction as an x component and μy which is an average value in the y axis direction as a y component. The calculation unit 150 obtains the average vector using the correct answer data. The process for obtaining the average vector will be described using FIG. 4 by way of an example.

FIG. 4 is obtained by superimposing the image acquired in step S101 on a map having the same size as the specific part likelihood map. Here, as an example, the size of the specific part correct answer map is 24 pixels horizontally (element)×16 pixels vertically (element), and the size of the image is 720 pixels horizontally×480 pixels vertically. In the coordinate system, the pixel position at the upper left corner is set as the origin (0,0), the horizontal right direction is set as the positive x axis, and the vertical downward direction is set as the positive y axis. Furthermore, a rectangle 1001 indicates a rectangular region indicated by the second region information included in the correct answer data, a point 1002 indicates the center coordinate of the rectangular region, and here, the center coordinate is (325, 40).

At this time, as described below, the calculation unit 150 divides the center coordinate (325, 40) by the size ratio between the image and the specific part correct answer map=720/24 (480/16)=30, and converts the result of the division into an integer value by rounding off or the like, and sets the result as an average vector.
μx: 325/30=10.83 . . . →(rounded off)→11
μy: 40/30=1.33 . . . →(rounded off)→1
Average vector μ=(μx, μy)=(11, 1)

Next, a process performed by the calculation unit 150 to obtain the loss for the specific part likelihood using the specific part correct answer map and the element product map will be described. As the loss function, a cross entropy loss represented by the following formula (2) is used.

$$\begin{matrix}[ Equation 5 ] & \\ loss = \frac{1}{N} \sum [ - {M}_{g t} log ( {M}_{i n f} ) - ( 1 - {M}_{g t} ) log ( 1 - {M}_{i n f} ) ] & ( 2 )\end{matrix}$$

Here, M_{inf} is an element product map, M_{gt} is a specific part correct answer map, and the summation (Σ) is performed for all elements (the number of elements N) of the element product map/specific part correct answer map.

In step S106, the calculation unit 150 obtains a loss with respect to the position and size of the tracking subject based on the map acquired in step S103 and the correct answer data acquired in step S101. The “map acquired in step S103” is any one or all of the tracking subject likelihood map, the size map, and the offset map. Since a method of obtaining the loss is known in Real-Time MDNet (ECCV 2018) or the like, the description thereof will be omitted here.

In step S107, the update unit 160 performs a learning process of the tracking subject detection model based on the loss obtained in step S105 and the loss obtained in step S106. For example, the update unit 160 updates the weight parameter of the tracking subject detection model so that the value of the linear sum of the loss obtained in step S105 and the loss obtained in step S106 becomes smaller, thereby performing the learning process of the tracking subject detection model. The learning process can be performed using, for example, an error back propagation method.

Such processes of steps S101 to S107 are repeatedly performed until the end condition of the learning process is satisfied. The learning end condition includes, for example, the number of repetitions of the processes of steps S101 to S107 being larger than or equal to a threshold value, the value of the linear sum being smaller than or equal to a threshold value, the difference between the previous value and the current value of the linear sum being smaller than or equal to a threshold value, and the like. When the end condition of the learning process is satisfied, the process according to the flowchart of FIG. 2 ends.

In the present embodiment, one piece of learning data is acquired in one learning process, but a plurality of pieces of learning data may be acquired at a time to perform the learning process. In that case, the processes in steps S102 to S106 are performed for each piece of learning data, and the process in step S107 is performed using the loss calculated for each piece of learning data.

As described above, in the present embodiment, learning is performed so that the element product map obtained by the element product of the specific part likelihood map and the specific part region map approaches the specific part correct answer map. That is, it can be said that a process of filtering only the specific part of the tracking subject from the specific part of each object is learned using the tracking subject detection model. At this time, the filter process can be performed in consideration of time-series information in which the position of the tracking subject continuously changes between frames by using a tracking subject model learned to detect the same tracking subject from images of different frames. As a result, the discriminability between the objects is enhanced as compared with the case of performing the correspondence of the specific part using the model learned by the independent image having no time-series property, the erroneous correspondence with another object is prevented, and the correspondence accuracy can be improved.

Note that the learning data set is not limited to being held by the learning apparatus 100, and may be held by an external apparatus. In this case, the learning apparatus 100 can access the external apparatus and acquire various types of data included in the learning data set.

### Second Embodiment

In the present embodiment, an inference apparatus that detects (infers) the position of the specific part of the tracking subject in the input image using the learned tracking subject detection model generated by the learning apparatus 100 according to the first embodiment will be described.

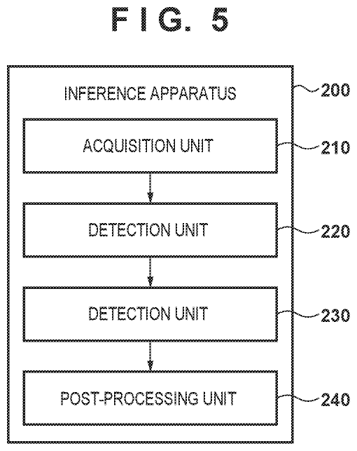

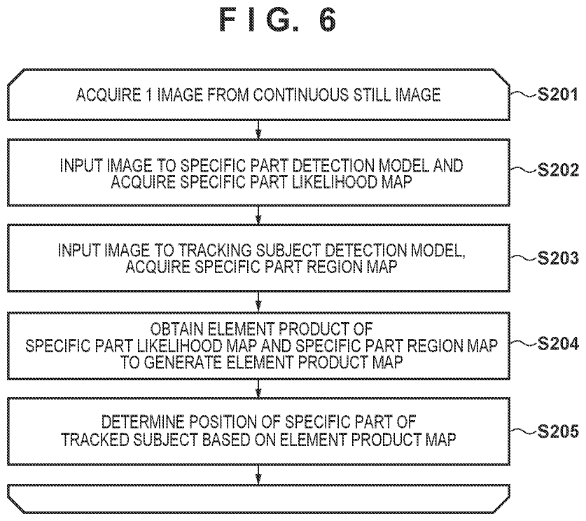

FIG. 5 is a block diagram illustrating a functional configuration example of an inference apparatus 200, according to the present embodiment. The process performed by the inference apparatus 200 to detect a specific part of the tracking subject in the input image using the learned tracking subject detection model generated by the learning apparatus 100 will be described with reference to the flowchart of FIG. 6. The process according to the flowchart of FIG. 6 illustrates a process performed on an image of one frame, and in a case where the process is performed on images of a plurality of frames, the process according to the flowchart of FIG. 6 is performed on each of the images of the plurality of frames.

In step S201, the acquisition unit 210 acquires an image for one frame. The image acquisition method is not limited to a specific acquisition method, and for example, an image may be acquired from an external apparatus connected to the inference apparatus 200 via a wired/wireless network such as a LAN or the Internet, or an image imaged by the imaging apparatus may be acquired.

In step S202, the detection unit 220 inputs the image acquired in step S201 to a specific part detection model (a model similar to the specific part detection model used by the learning apparatus 100) and performs a calculation process of the specific part detection model. The detection unit 220 acquires “the specific part likelihood map corresponding to the image acquired in step S201” that is the output of the specific part detection model by such calculation process.

Note that the detection unit 220 may acquire a “size map indicating the size of the specific part included in the image acquired in step S201”, “offset map representing correction information for correcting the position of a specific part included in the images acquired in step S201”, or the like using the specific part detection model or other learned models.

In step S203, the detection unit 230 inputs the image acquired in step S201 to a tracking subject detection model (a learned tracking subject detection model in the learning apparatus 100) and performs a calculation process of the tracking subject detection model. The detection unit 230 acquires “the specific part region map corresponding to the image acquired in step S201” which is the output of the tracking subject detection model by such a calculation process.

In step S204, a post-processing unit 240 generates a map obtained by calculating an element product of the specific part likelihood map acquired in step S202 and the specific part region map acquired in step S203 as an element product map.

In step S205, the post-processing unit 240 detects the position of the specific part of the tracking subject based on the element product map generated in step S204. The post-processing unit 240 specifies coordinates (peak coordinates) (xp, yp) of the element having the largest element value in the element product map, multiplies the peak coordinates (xp, yp) by the size ratio described above to convert the coordinates into coordinates on the image, and sets the converted coordinates as the position of the specific part of the tracking subject on the image. The post-processing unit 240 obtains the size ratio by the method described in the first embodiment.

Furthermore, when the specific part detection model outputs the size map and the offset map, the post-processing unit 240 determines the element value of the element at the peak coordinate in each map to the size/offset of the specific part.

Note that, although the tracking subject and the specific part (head) are corresponded in the present embodiment, the specific parts of the tracking subject can be corresponded with each other by outputting a plurality of specific part likelihood maps and specific part region maps and corresponding each specific part with the tracking subject.

### Third Embodiment

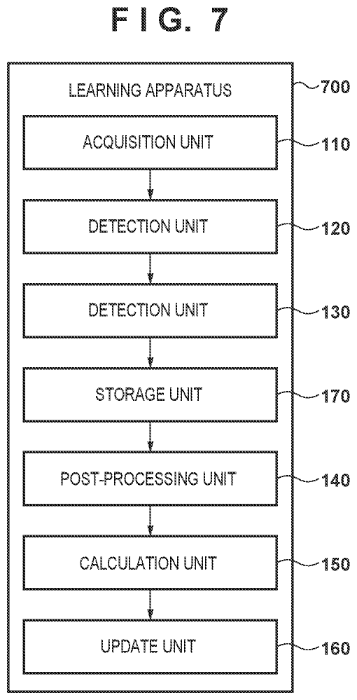

In the present embodiment, a new loss is added to the loss calculated by the calculation unit 150. FIG. 7 is a block diagram illustrating a functional configuration example of the learning apparatus 700, according to the present embodiment. In FIG. 7, functional units similar to the functional units illustrated in FIG. 1 are denoted by the same reference numerals, and the functional units will not be described or will be briefly described.

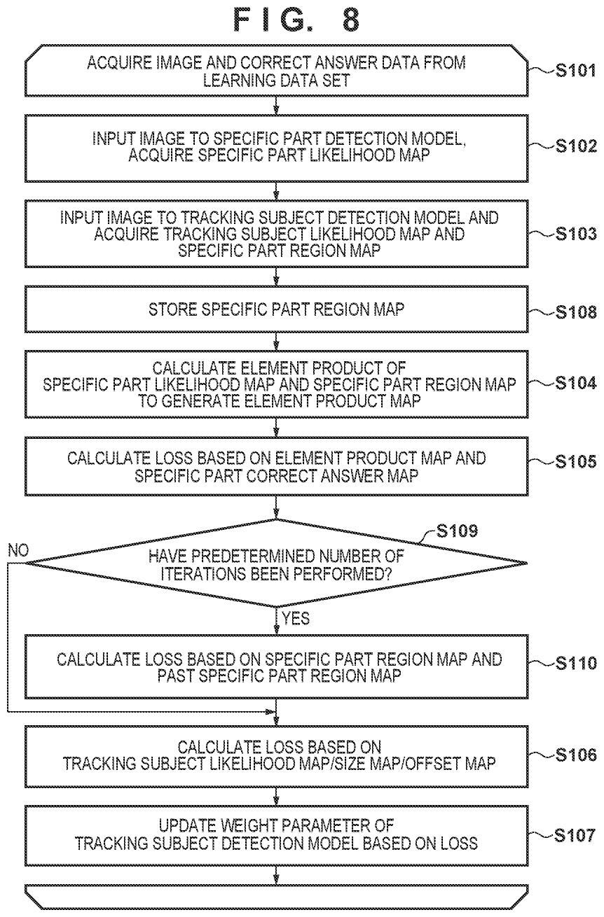

A learning process by the learning apparatus 700 according to the present embodiment will be described with reference to the flowchart of FIG. 8. In FIG. 8, processing steps similar to the processing steps illustrated in FIG. 2 are denoted by the same step numbers, and the processing steps will not be described or will be briefly described.

In step S108, the detection unit 130 stores the specific part region map in the storage unit 170. In step S109, the calculation unit 150 determines whether or not the number of times the process according to the flowchart of FIG. 8 is executed is n times or more (iterations of n times or more have been performed). As a result of the determination, in a case where the number of times the process according to the flowchart of FIG. 8 is executed is n times or more, the process proceeds to step S110, and in a case where the number of times the process according to the flowchart of FIG. 8 is executed is less than n times, the process proceeds to step S106.

In step S110, the calculation unit 150 obtains a loss for the specific part region based on the specific part region map acquired in step S103 this time and the “specific part region map acquired in past step S103” stored in the storage unit 170.

The calculation unit 150 first selects a plurality of specific part region maps as the selected specific part region map from the specific part region maps stored in the storage unit 170. For example, the calculation unit 150 selects, as the selection specific part region map, the specific part region map stored in the storage unit 170 in step S108 n (n is a natural number of greater than or equal to 2) times before to the specific part region map stored in the storage unit 170 in the previous step S108. Then, the calculation unit 150 generates a map obtained by averaging (moving average) the selected n selected specific part region maps as the correct answer specific part region map.

Then, the calculation unit 150 obtains a loss using the cross entropy loss expressed in the above formula (2) as a loss function. In this step, M_{inf} is the specific part region map acquired in the current step S103, and M_{gt} is the correct answer specific part region map.

In step S107 according to the present embodiment, in a case where the loss is obtained in step S110, the update unit 160 performs the learning process of the tracking subject detection model based on the loss obtained in step S105, the loss obtained in step S106, and the loss obtained in step S110. On the other hand, in a case where step S110 is skipped, similarly to the first embodiment, the update unit 160 performs the learning process of the tracking subject detection model based on the loss obtained in step S105 and the loss obtained in step S106.

As described above, in the present embodiment, learning is performed so that the difference between the current specific part region map and the past specific part region map becomes small. That is, it can be said that learning is performed such that the output of the specific part region map is consistent in time series. As a result, it is possible to suppress a large change in the specific part existing region between frames due to an erroneous reaction to an object other than the tracking subject, and to prevent erroneous correspondence with another object. In addition, by using a map calculated from a plurality of past specific part region maps as a correct answer value, in a case where the movement of the tracking subject in the continuous still image is large, the distribution of the calculated correct answer specific part region map has a wide skirt. As a result, learning that allows spread of the distribution of the output specific part region map can be performed, and the region where the specific part can exist can be appropriately estimated even for an object with large movement such as an athlete.

### Fourth Embodiment

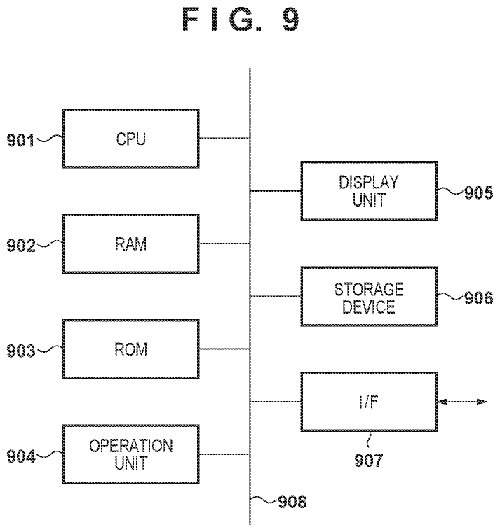

The functional units illustrated in FIGS. 1, 5, and 7 may be implemented by hardware, and other functional units other than the storage unit 170 may be implemented by software (computer program). In the latter case, the computer apparatus that can execute the computer program is applicable to the learning apparatus 100, the inference apparatus 200, and the learning apparatus 700. A hardware configuration example of a computer apparatus applicable to the learning apparatus 100, the inference apparatus 200, and the learning apparatus 700 will be described with reference to a block diagram of FIG. 9.

A CPU 901 executes various types of processes using computer programs and data stored in a RAM 902. As a result, the CPU 901 controls the operation of the entire computer apparatus, and executes or controls various types of processes described as a process performed by a device to which the computer apparatus is applied (learning apparatus 100, inference apparatus 200, learning apparatus 700).

The RAM 902 includes an area for storing computer programs and data loaded from the ROM 903 or a storage device 906, or an area for storing data externally received via an I/F 907. The RAM 902 also has a work area used when the CPU 901 performs various processes. The RAM 902 can thus provide various areas as appropriate.

The ROM 903 stores setting data of the computer apparatus, computer programs and data related to activation of the computer apparatus, computer programs and data related to basic operations of the computer apparatus, or the like.

An operation unit 904 is a user interface such as a keyboard, a mouse, and a touch panel screen, and can input various types of instructions to the CPU 901 by a user operation.

A display unit 905, having a liquid crystal screen or a touch panel screen, can display results of processing by the CPU 901 via images, characters, or the like. Note that the display unit 905 may be a projection device such as a projector that projects images or characters.

The external storage device 906 is a large-capacity information storage device such as a hard disk drive device. The storage device 906 stores a computer program, data, and the like for causing the CPU 901 to execute or control various types of processes described as processes performed by an operating system (OS), the learning apparatus 100, the inference apparatus 200, and the learning apparatus 700. The computer programs and data stored in the storage device 906 are loaded to the RAM 902 as appropriate according to the control by the CPU 901, which are then subjected to processing by the CPU 901. Note that the storage unit 170 can be implemented using, for example, the RAM 902 or the storage device 906.

The I/F 907 is a communication interface for performing data communication with an external apparatus via a wired/wireless network such as a LAN or the Internet. The CPU 901, the RAM 902, the ROM 903, the operation unit 904, the display unit 905, the storage device 906, and the I/F 907 are all connected to the system bus 908.

Note that a computer apparatus having the same configuration may be applied to the learning apparatus and the inference apparatus, or a computer apparatus having different configurations may be applied to the learning apparatus and the inference apparatus.

Alternatively, the numerical values, processing timings, processing orders, processing entities, and data (information) acquiring method/transmission destination/transmission source/storage location, and the like used in the embodiments described above are referred to by way of an example for specific description, and are not intended to be limited to these examples.

Alternatively, some or all of the embodiments described above may be used in combination as appropriate. Alternatively, some or all of the embodiments described above may be selectively used.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-024622, filed Feb. 20, 2023, which is hereby incorporated by reference herein in its entirety.

What is claimed is:

1. A learning apparatus comprising one or more memories storing instructions and one or more processors that execute the instructions to:
acquire a likelihood map of a specific part in an input image by using a first model for detecting the specific part;
acquire a region map representing a region of a specific part of a tracking target in the input image by using a second model for detecting the tracking target; and
perform learning of the second model based on a loss obtained based on an element product map obtained by an element product of the likelihood map and the region map and correct answer data indicating a region of a specific part of a tracking target in the input image.

2. The learning apparatus according to claim 1, wherein the one or more processors execute the instructions to obtain, as the correct answer map, a two dimensional likelihood distribution in which a result obtained by dividing a center coordinate of a region represented by the correct answer data by a size ratio between the correct answer map and the input image is an average vector, and perform learning of the second model based on a loss obtained based on the correct answer map and the element product map.

3. The learning apparatus according to claim 1, wherein the one or more processors execute the instructions to perform learning of the second model based on the loss and a loss obtained based on the region map and an average of a plurality of region maps acquired in the past.

4. The learning apparatus according to claim 1, wherein the one or more processors execute the instructions to acquire a likelihood map of the tracking target in the input image using the second model.

5. An inference apparatus comprising one or more memories storing instructions and one or more processors that execute the instructions to:
acquire a likelihood map of a specific part in an input image by using a first model for detecting the specific part;
acquire a region map representing a region of a specific part of a tracking target in the input image by using a second model for detecting the tracking target; and
detect a position of the specific part in the input image based on an element product map obtained by an element product of the likelihood map and the region map.

6. The inference apparatus according to claim 5, wherein the one or more processors execute the instructions to detect the position of the specific part in the input image based on coordinates of an element having a maximum element value in the element product map.

7. A learning method comprising:
acquiring a likelihood map of a specific part in an input image by using a first model for detecting the specific part;
acquiring a region map representing a region of a specific part of a tracking target in the input image by using a second model for detecting the tracking target; and
performing learning of the second model based on a loss obtained based on an element product map obtained by an element product of the likelihood map and the region map and correct answer data indicating a region of a specific part of a tracking target in the input image.

8. An inference method comprising:
acquiring a likelihood map of a specific part in an input image by using a first model for detecting the specific part;
acquiring a region map representing a region of a specific part of a tracking target in the input image by using a second model for detecting the tracking target; and
detecting a position of the specific part in the input image based on an element product map obtained by an element product of the likelihood map and the region map.

9. A non-transitory computer-readable storage medium storing a computer program for causing a computer to function as:
a first acquisition unit configured to acquire a likelihood map of a specific part in an input image by using a first model for detecting the specific part;
a second acquisition unit configured to acquire a region map representing a region of a specific part of a tracking target in the input image by using a second model for detecting the tracking target; and
a learning unit configured to perform learning of the second model based on a loss obtained based on an element product map obtained by an element product of the likelihood map and the region map and correct answer data indicating a region of a specific part of a tracking target in the input image.

10. A non-transitory computer-readable storage medium storing a computer program for causing a computer to function as:
a first acquisition unit configured to acquire a likelihood map of a specific part in an input image by using a first model for detecting the specific part;
a second acquisition unit configured to acquire a region map representing a region of a specific part of a tracking target in the input image by using a second model for detecting the tracking target; and
a detection unit configured to detect a position of the specific part in the input image based on an element product map obtained by an element product of the likelihood map and the region map.
